(19) United States
(12) Patent Application Publication
(10) Pub. No.: US 2006/0053145 A1
(43) Pub. Date: Mar. 9, 2006

(54) System and method for data dispatch

(76) Inventors: Ilkka Salminen, Tampere (FI); Harri Lakkala, Tampere (FI); Riku Suomela, Tampere (FI); Attila Kiss, Szekesfehervar (HU); Balazs Bakos, Torokbalint (HU)

Correspondence Address: MORGAN & FINNEGAN, L.L.P., 3 WORLD FINANCIAL CENTER, NEW YORK, NY, 10281-2101, US

(21) Appl. No.: 10/935,553

(22) Filed: Sep. 7, 2004

(51) Int. Cl. G06F 17/30

(52) U.S. Cl. 707/102

(57) ABSTRACT

Systems and methods applicable, for instance, in data dispatch. For example, a series of nodes and/or other computers may be employed such that passing of data, via proximity connection, from node and/or other computer to node and/or other computer in the series results in the data being received by an intended recipient node and/or other computer. A node and/or other computer of the series might come to be in proximity connection range with another node and/or other computer of the series, for instance, by way of user translocation of one or more of the nodes and/or other computers.

### FIELD OF INVENTION

This invention relates to systems and methods for data dispatch.

### BACKGROUND INFORMATION

In recent years, users have increasingly come to rely upon computers (e.g., wireless nodes) for dispatch of various data. For example, users have increasingly come to dispatch audio, video, images, software, documents, and organizer data.

Accordingly, there may be interest in technologies that facilitate such use of computers.

### SUMMARY OF THE INVENTION

According to embodiments of the present invention there are provided systems and methods applicable, for instance, in data dispatch.

For example, a series of nodes and/or other computers might be employed such that passing of data, via proximity connection, from node and/or other computer to node and/or other computer in the series results in the data being received by an intended recipient node and/or other computer. A node and/or other computer of the series might come to be in proximity connection range with another node and/or other computer of the series, for instance, by way of user translocation of one or more of the nodes and/or other computers.

### BRIEF DESCRIPTION OF THE DRAWINGS

FIG. 1 shows exemplary operation according to various embodiments of the present invention.

FIG. 2 shows exemplary data according to various embodiments of the present invention.

FIG. 3 shows further exemplary data according to various embodiments of the present invention.

FIG. 4 shows still further exemplary data according to various embodiments of the present invention.

FIG. 5 shows an exemplary computer.

FIG. 6 shows a further exemplary computer.

### DETAILED DESCRIPTION OF THE INVENTION

General Operation

According to embodiments of the present invention there are provided systems and methods applicable, for instance, in data dispatch.

For example, a series of nodes and/or other computers may, in various embodiments, be employed such that passing of data, via proximity connection (e.g., IEEE 802.11, Bluetooth, Infrared Data Access (IrDA), and/or Ultra Wide Band (UWB)), from node and/or other computer to node and/or other computer in the series results in the data being received by an intended recipient node and/or other computer. Data might, in various embodiments, be passed via Object Exchange (OBEX) Object Push Profile (OPP), Simple Object Access Protocol (SOAP), and/or the like. A node and/or other computer of the series might come to be in proximity connection range with another node and/or other computer of the series, for instance, by way of user translocation of one or more of the nodes and/or other computers. Nodes and/or other computers making up such a series could, for instance, be in view of encounters between nodes and/or other computers.

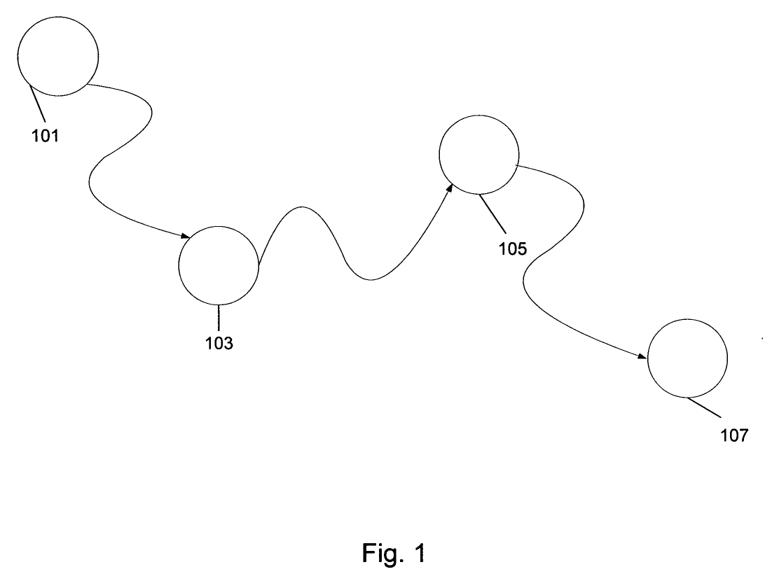

To illustrate by way of example with reference to FIG. 1, the data might first be passed via proximity connection from an initiating node and/or other computer (101) to a second node and/or other computer (103), with the second node and/or other computer (103) being in proximity connection range with the initiating node and/or other computer (101) but not in proximity connection range of a third node and/or other computer (105).

The second node and/or other computer (103) might then, by way of being moved by its user, be brought into proximity connection range with the third node and/or other computer (105), but not into proximity connection range with an intended recipient node and/or other computer (107). The data might subsequently be passed via proximity connection from the second node and/or other computer (103) to the third node and/or other computer (105).

The third node and/or other computer (105) might then, by way of being moved by its user, be brought into proximity connection range with the intended recipient node and/or other computer (107), and the data might subsequently be passed via proximity connection from the third node and/or other computer (105) to the intended recipient node and/or other computer (107).

The second (103) and third (105) nodes and/or other computers might be employed for such operation, for example, in view of past and/or planned future encounters between the initiating node and/or other computer (101) and the second node and/or other computer (103), between the second node and/or other computer (103) and the third node and/or other computer (105), and/or between the third node and/or other computer (105) and the intended recipient node and/or other computer (107).

Various aspects of the present invention will now be discussed in greater detail.

Calculation of Direct Proximity Weights

According to various embodiments of the present invention, a node and/or other computer may act to calculate one or more direct proximity weights with respect to one or more other nodes and/or other computers.

A direct proximity weight could, for example serve to provide evaluation regarding direct proximity connection between two nodes and/or other computers such that the value could, for instance, be taken into account in a decision to employ such a connection for data transmission. Such values might, for instance, range from 0 to 1 (e.g., with higher values being considered to more desirable).

Calculation of a direct proximity weight by a node and/or other computer with respect to another node and/or other computer may take into account a variety of factors. For example, past occurrences of the nodes and/or other computers being in proximity connection range with each other, planned future occurrences of the nodes and/or other computers being in proximity connection range with each other, and/or connection speeds established for proximity connections between the two nodes and/or other computers might be considered.

Consideration of past occurrences of the nodes and/or other computers being in proximity connection range with each other might, for example, involve consideration of log entries regarding proximity connections with the other node and/or other computer (e.g., for file transfer), consideration of past calendar events (e.g., calendar events associated with organizer software) involving the other node and/or other computer and/or its user (e.g., indicating that a meeting with the user of the other node and/or other computer had occurred and/or had been scheduled to occur in the past), and/or indications that the two nodes and/or other computers had visited common locations. Frequencies and/or other statistics might, in various embodiments, be calculated and/or obtained (e.g., a frequency with which the other node and/or other computer was in proximity connection range in the past).

With regard to indications concerning common locations, it is noted that, for instance, nodes and/or other computers might log visited locations and make these locations available to other nodes and/or other computers (e.g., via exchanging such data with other nodes and/or other computers, and/or by submitting such to a server accessible by other nodes and/or other computers). Such logging might, for example involve recordation of latitude-longitude coordinates (perhaps acquired via Global Positioning System (GPS) hardware), and/or location indications provided by beacons and/or access points. Such location data might, perhaps, be made available to other nodes and/or other computers in one-way hashed form. In such cases, a node and/or other computer might act to determine commonly-visited locations by performing the same type of hash used for the received location data with respect to its visited locations, and comparing those hashes with received location data.

Consideration of planned future occurrences of the nodes and/or other computers being in proximity connection range with each other might, for example, involve consideration of future calendar events involving the other node and/or other computer and/or its user (e.g., indicating that a meeting with the user of the other node and/or other computer was scheduled to occur at a future date). Frequencies and/or other statistics might, in various embodiments, be calculated and/or obtained (e.g., frequency with which the other node and/or other computer was expected to be in proximity connection range in the future).

Associated with a calculated direct proximity weight may, perhaps, be one or more identifiers (e.g., a phone number, a network address, a media access control (MAC) address, a Bluetooth identifier, a serial number, a friendly name (e.g., a user-selected name), and/or other identifier) corresponding to the other node and/or other computer (referred to, perhaps, as the “target” node and/or other computer for that weight).

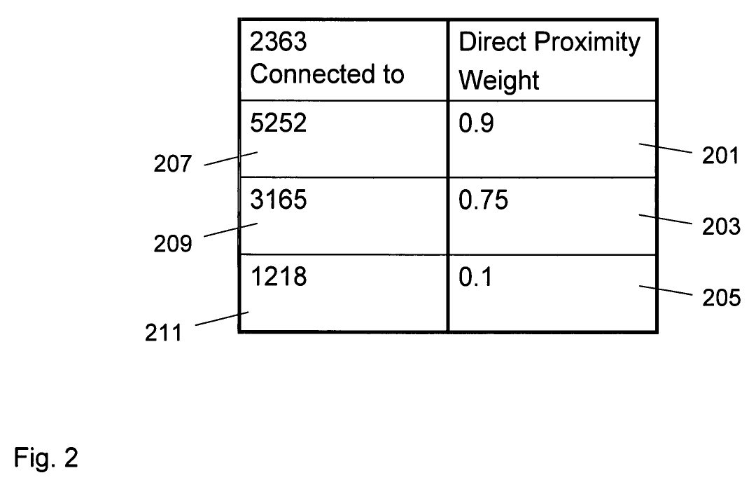

Shown in FIG. 2 is exemplary data held and/or accessible by a particular node and/or other computer (with identifier “2363” in this example) according to various embodiments of the present invention including direct proximity weights (201-205) and identifiers (207-211) for corresponding target nodes and/or other computers. For instance, exemplary direct proximity weight 201 corresponds direct proximity connection between the particular node and/or other computer and a node and/or other computer and/or other computer with associated identifier “5252”.

It is noted that, in various embodiments, nodes and/or other computers may be organized into groups. In various embodiments, groups may be taken into account in direct proximity weight calculation. For instance, a group direct proximity weight, serving to provide evaluation regarding direct proximity connection between a node and/or other computer and a group, might be calculated.

Such calculation might, for instance, take into account the notion that direct proximity connection with a group is achievable by direct proximity connection with any node and/or other computer of that group.

For example, in the case where past occurrences indicated that a node and/or other computer was in proximity connection range with a first node and/or other computer of a group every weekday but not on weekends, and was in proximity connection range with a second node and/or other computer of the group every Saturday and every Sunday but not on weekdays, a direct proximity weight for the group might, for instance, reflect the notion that a direct proximity connection with the group could be expected every day.

Calculation of Indirect Proximity Weights

An indirect proximity weight could, in various embodiments, serve to provide evaluation regarding a data path from an originator node and/or other computer to a target node and/or other computer via one or more intermediate nodes and/or other computers wherein data is passed from node and/or other computer to node and/or other computer via proximity connections.

To illustrate by way of example, the data path may be such that data is passed from the originator node and/or other computer to a first intermediate node and/or other computer via a proximity connection, from the first intermediate node and/or other computer to a second intermediate node and/or other computer via a proximity connection, and from the second intermediate node and/or other computer to the target node and/or other computer via a proximity connection.

An indirect proximity weight could, for instance, be taken into account in a decision to employ a corresponding data path for a data transmission. Associated with an indirect proximity weight may, perhaps, be one or more identifiers (e.g., of the sort discussed above) corresponding to one or more nodes and/or other computers of the corresponding data path. For instance, returning to the above illustrative example, associated with a corresponding indirect proximity weight might be one or more identifiers corresponding to the originator node and/or other computer, the target node and/or other computer, the first intermediate node and/or other computer, and/or the second intermediate node and/or other computer.

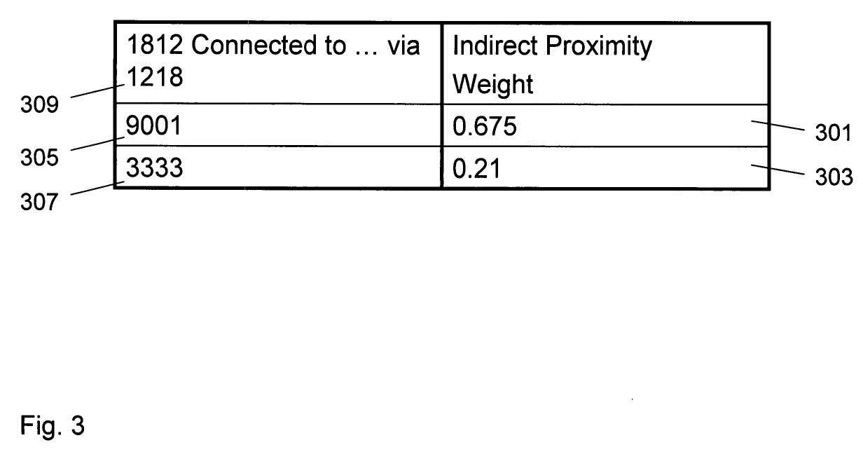

Shown in FIG. 3 is exemplary data held and/or accessible by a particular node and/or other computer (with identifier “1812” in this example) according to various embodiments of the present invention including indirect proximity weight 301 and corresponding target node and/or other computer identifier 305, indirect proximity weight 303 and corresponding target node and/or other computer identifier 307, and a first intermediate node and/or other computer identifier (identifier “1218”, see element 309). It is noted that a “first” intermediate node and/or other computer might be the only intermediate node and/or other computer of a particular data path (to illustrate by way of example, data might be passed from an originator node and/or other computer, to a single intermediate node and/or other computer, and from the single intermediate node and/or other computer to a target node and/or other computer).

It is noted that, in various embodiments, where there is more than one intermediate node and/or other computer for a data path, identifiers for all intermediate nodes and/or other computers might be associated or, alternately, only one or more identifiers for a first intermediate node and/or other computer might be associated. Order of use for the intermediate nodes and/or other computers might, perhaps, be specified.

A node and/or other computer may, according to various embodiments of the present invention, act to calculate one or more indirect proximity weights with respect to one or more other nodes and/or other computers. Alternately or additionally, such calculations may be performed by another device.

For example, a node and/or other computer may receive proximity weights from another node and/or other computer, and/or may provide proximity weights to another node and/or other computer. Such proximity weights might, for instance, be direct proximity weights as discussed above and/or indirect proximity weights as described in this section. Nodes and/or other computers might, for instance, exchange proximity weights via proximity connection (e.g., nodes and/or other computers might exchange proximity weights upon coming into proximity connection range with one another).

In various embodiments, a node and/or other computer might receive along with a received indirect proximity weight indication of one or more corresponding nodes and/or other computers (e.g., identifiers corresponding an originator node and/or other computer, a target node and/or other computer, and/or one or more intermediate nodes and/or other computers).

Having received direct and/or indirect proximity weights a node and/or other computer may, in various embodiments, act to employ the received proximity weights and held and/or accessible direct and/or indirect proximity weights in calculating one or more indirect proximity weights. Such functionality may be implemented in a number of ways.

For example, a node and/or other computer may act to calculate an indirect proximity weight by performing a mathematical operation wherein a received direct proximity weight and a held and/or accessible direct proximity weight are operands. The multiplication operator might, for instance, be applied to the operands.

As another example, a node and/or other computer may act to calculate an indirect proximity weight by performing a mathematical operation wherein a received indirect proximity weight and a held and/or accessible direct proximity weight are operands. The multiplication operator might, for instance, be applied to the operands.

A node and/or other computer may, perhaps, act to associate indication of one or more nodes and/or other computers with a calculated indirect proximity weight. For instance, in the case where a first node and/or other computer received from a second node and/or other computer an indirect proximity weight with respect to a target node and/or other computer, an indirect proximity weight newly-calculated by the first node and/or other computer using the received indirect proximity weight might be associated with an identifier for the target node and/or other computer and/or an identifier for the second node and/or other computer, with the second node and/or other computer being considered to be the first intermediate node and/or other computer with respect to the newly-calculated indirect proximity weight (as noted above, a “first” intermediate node and/or other computer might be the only intermediate node and/or other computer of a particular data path).

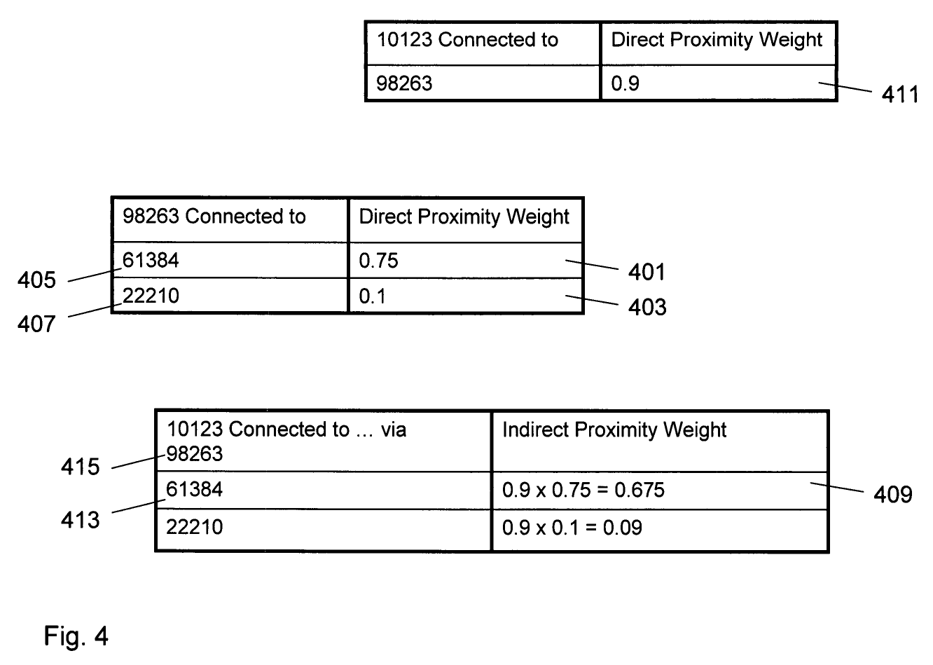

FIG. 4 corresponds to an illustrative example wherein a node and/or other computer having identifier “10123” receives from a node and/or other computer having identifier “98263” direct proximity weights 401 and 403, and associated target node and/or other computer identifiers 405 and 407.

In the example of FIG. 4, for received direct proximity weight 401 (for which the target node and/or other computer has identifier “61384”), the node and/or other computer having identifier “10123” calculates indirect proximity weight 409 for which the node and/or other computer having identifier “61384” is the target node and/or other computer, and for which the node and/or other computer having identifier “98263” is the first intermediate node and/or other computer. Such is calculated by multiplying the received direct proximity weight 401 by the direct proximity weight 411 (weight 411 regarding direct proximity connection between the node and/or other computer having identifier “10123” and the node and/or other computer having identifier “98263”). Although multiplication is shown in this example, in various embodiments other techniques may be employed in weight calculation.

In this example, for the calculated indirect proximity weight 409, the node and/or other computer having identifier “10123” stores an identifier 413 for the corresponding target node and/or other computer, and an identifier (identifier “98263”, see element 415) for the corresponding first intermediate node and/or other computer.

It is noted that, in various embodiments, a node and/or other computer could act to delete and/or ignore one or more held and/or accessible direct and/or indirect proximity weights. For example, the node and/or other computer might act to delete and/or ignore proximity weights not meeting a threshold criteria (e.g., it might act to delete and/or ignore proximity weights above or below a value specified, for instance, by a system administrator, service provider, manufacturer, and/or user).

As another example, the node and/or other computer might act to delete and/or ignore proximity weights for which it was the target node and/or other computer.

As yet another example, the node and/or other computer might act to delete and/or ignore proximity weights, other than one considered to be best (e.g., the highest value), specifying a particular node and/or other computer as target node and/or other computer. To illustrate by way of example, in the case where a node and/or other computer held and/or had access to two proximity weights for which a particular node and/or other computer was the target node and/or other computer, one having a value of 0.25 and the other having a value of 0.80, the proximity weight having a value of 0.25 might be deleted and/or ignored.

In the case where a plurality of proximity weights have the same value and that value is considered to be best, one or more operations might, perhaps, be performed. For example, none of those weights might be deleted and/or ignored, or all of those weights except a randomly selected one might be deleted and/or ignored. It is noted that, in various embodiments, in the case where a direct proximity weight and an indirect proximity weight were equal, the direct proximity weight might be considered more desirable than the other, with deletion and/or ignoring perhaps accordingly occurring.

As indicated above, in various embodiments, nodes and/or other computers may be organized into groups. Groups may, in various embodiments, be taken into account in calculation of indirect proximity weights.

For example, in various embodiments one or more group direct proximity weights might be employed in calculating indirect proximity weights, and/or indirect proximity weights might be calculated for groups.

Data Dispatch

According to various embodiments of the present invention, in the case where data (e.g., audio, video, images, software, documents, and/or organizer data) is to be dispatched from a node and/or other computer to an intended recipient node and/or other computer (e.g., in accordance with a request by a user) the node and/or other computer initiating dispatch may, for example, act to consult held and/or accessible direct proximity weights and/or indirect proximity weights to find proximity weights for which the corresponding target node and/or other computer is the intended recipient node and/or other computer.

In the case where more than one such proximity weight is discovered, the computer initiating dispatch may, perhaps, act to select a particular one for use. Such selection might, for instance, be performed in a manner analogous to that discussed above with respect to deletion and/or ignoring of weights. Accordingly, for example, the proximity weight considered to be the best (e.g., the one having the highest value) might be chosen for use.

In the case where the selected proximity weight is a direct proximity weight, the node and/or computer initiating dispatch may, for example, act to forward the data to the intended recipient node and/or other computer via a proximity connection with that node and/or other computer. Accordingly, for instance, the node and/or other computer initiating dispatch might attempt to do so the next time it came into proximity connection range with the intended recipient node and/or other computer. Having received the data, the intended recipient node and/or other computer might, perhaps perform one or more operations with respect to the data (e.g., placing it in an appropriate store, informing its user, and/or launching software).

In the case where the selected proximity weight is an indirect proximity weight, the node and/or other computer initiating dispatch may, for example, act to forward the data to the proximity weight's specified first intermediate node and/or other computer via a proximity connection with that node and/or other computer. Accordingly, for instance, the node and/or other computer initiating dispatch might attempt to do so the next time it came into proximity connection range with the specified first intermediate node and/or other computer. As noted above, a “first” intermediate node and/or other computer might be the only intermediate node and/or other computer of a particular data path.

A node and/or other computer receiving such data might, for example, act to determine if it was the intended recipient node and/or other computer. Indication of the intended recipient might, in various embodiments, be included with the data (e.g., via one or more identifiers of the sort discussed above). In the case where the node and/or other computer was the intended recipient, the node and/or other computer might, perhaps, perform one or more appropriate actions with respect to the data (e.g., of the sort discussed above).

In the case where the node and/or other computer was not the intended recipient, the node and/or other computer might, perhaps, act to select a next node and/or other computer to receive the data via proximity connection. Such functionality may be implemented in a number of ways.

For example, in various embodiments each node and/or other computer might hold and/or have access to more than one proximity weight specifying any given node and/or other computer as target node and/or other computer. Such might come to be the case, for instance, because of deleting and/or ignoring operations of the sort discussed above. In such embodiments, in the case where the node and/or other computer receiving the data was not the intended recipient, it might, for instance, access the single held and/or accessible proximity weight specifying the intended recipient node and/or other computer as target node and/or other computer.

In the case where the accessed corresponding proximity weight was a direct proximity weight, the node and/or other computer might, for instance, perhaps in a manner analogous to that discussed above, forward the data to the intended recipient node and/or other computer via proximity connection.

In the case where the appropriate corresponding proximity weight was an indirect proximity weight, the node and/or other computer might, for instance, perhaps in a manner analogous to that discussed above, forward the data, via proximity connection, to the node and/or other computer specified by the proximity weight to be first intermediate node and/or other computer.

As another example, in various embodiments included along with the data by the node and/or other computer initiating dispatch might be indication of the intended recipient node and/or other computer, and each intermediate node and/or other computer to be employed in dispatching the data to the intended recipient node and/or other computer, along with specification of order of use for the intermediate nodes and/or other computers. In various embodiments, one or more identifiers of the soft discussed above might be employed.

Accordingly, the node and/or other computer that was not the intended final recipient might, for instance, act to determine the next node and/or other computer to receive the data (e.g., it might consult the specified order). Having done so the node and/or other computer might act, perhaps in a manner analogous to that discussed above, to, as appropriate, forward the data to the next intermediate node and/or other computer, or to the intended recipient node and/or other computer.

It is noted that a node and/or other computer receiving data from an intermediate node and/or other computer could, for example, act in a manner analogous to that discussed with respect to a node and/or other computer receiving data from a node and/or other computer initiating dispatch.

It is further noted that, in various embodiments, a node and/or other computer initiating dispatch might act to decide if the data to be dispatched should be dispatched via proximity connections as discussed herein, or in a manner employing one or more Wide Area Networks (WANs). Such WAN use might, for instance, involve use of General Packet Radio Service (GPRS) and/or Universal Mobile Telecommunications Service (UMTS). Such decision could take into account various factors.

For example, a weight threshold criteria (e.g., a minimum weight) might be associated with data to be dispatched, and in the case where consideration of held and/or accessible proximity weights did not yield an appropriate proximity weight meeting the criteria, the node and/or other computer initiating dispatch could act to send the data to the intended recipient in a manner involving WAN use.

As another example, one or more priorities might be associated with data to be dispatched. Such a priority might, for instance, be set by a user of the node and/or other computer initiating dispatch, a system administrator, a service provider, and/or a manufacturer. The node and/or other computer initiating dispatch might, perhaps, take priority into account in determining whether to send the data to be dispatched via proximity connection as discussed herein, or in a manner involving WAN use.

For instance, correlations between priority values and proximity weights might be established (e.g., by a system administrator, service provider, manufacturer, and/or user) such that, for example, data would be dispatched via WAN use rather than via one or more proximity connections, in the case where consideration of held and/or accessible proximity weights did not yield an appropriate proximity weight having a value sufficient for a priority specified for the data.

It is noted that, in various embodiments, additional factors (e.g., cost of WAN use and/or size of data to be dispatched) could be taken into account. For example, functionality might be such that in the case where size was larger and/or WAN use cost was higher, a less favorable proximity weight might be considered acceptable for a given priority. Such functionality might be implemented, for instance, by having correlations between priority values and proximity weights be size, delay, and/or cost dependent. Such dependency might, perhaps, be in accordance with specification by a system administrator, service provider, manufacturer, and/or user.

As indicated above, in various embodiments, nodes and/or other computers may be organized into groups. Accordingly, for example, dispatched data might be meant for an intended recipient group.

Group functionality might, for example be such that nodes and/or other computers of a group hold and/or access proximity weights corresponding to other nodes and/or other computers of the group. As another example, group functionality might be such that multicasting is employed in data dispatch. As yet another example, group functionality might be such that data received by any member of a group ends up being received by every member of the group (e.g., via communication among nodes and/or other computers that are members of the group).

It is noted that, in various embodiments, various security functionality may be implemented. For instance, applicable to data to be dispatched might be a security attribute indicating that data to be personal and/or secret. Such an attribute might, for example, be applied responsive to request by a user (e.g., via a GUI and/or other interface).

In various embodiments, in the case where such an attribute is applied to data to be dispatched, operation may be such that the data is not passed to intermediate nodes and/or other computers that are not trusted. Accordingly, application of such an attribute to data to be dispatched might, for example, affect composition of a series of nodes and/or other computers employed in delivering that data to an intended recipient, and/or be taken to account in indirect proximity weight calculation.

Functionality for determining whether a node and/or other computer was trusted might be implemented in a number of ways. For example, a node and/or other computer might be considered to be trusted if it was referenced by data (e.g., by a phonebook) of the initiating node and/or other computer.

In various embodiments, an initiating node and/or other computer may receive confirmation of proper receipt of dispatched data by an intended recipient. Such confirmation might, for example, be sent directly from an intended recipient node and/or other computer, and/or from a node and/or other computer of an intended recipient group, to an initiating node and/or other computer, perhaps via use of GPRS, UMTS, Short Message Service (SMS), Multimedia Messaging Service (MMS), email, OBEX OPP, and/or SOAP.

It is further noted that, in various embodiments, a due date may be settable for data to be dispatched. The due date might, for example, be settable by a user (e.g., via a GUI and/or other interface). Such a due date might be employed in a number of ways. For example, in various embodiments in the case where an initiating node and/or other computer did not receive, by the due date associated with data, confirmation of proper receipt of that data, the node and/or other computer might act to directly transfer the data to the intended recipient. Such transfer might, for example, involve use of GPRS, UMTS, SMS, MMS, email, OBEX OPP, and/or SOAP.

Operational Aspects

According to various embodiments of the present invention, one or more operations may be performed in order to determine if a node and/or or other computer in proximity connection range should receive held data. Such functionality may be implemented in a number of ways.

For example, a node and or other computer holding and/or having access to data to be dispatched might hold and/or have access to identifiers corresponding to one or more nodes and/or other computers that are to receive the data (e.g., as intended recipient nodes or as intermediate nodes). Such identifiers might, for instance, be those of the sort discussed above (e.g., phone numbers, network addresses, MAC addresses, Bluetooth identifiers, serial numbers, friendly names (e.g., user-selected names), and/or other identifiers).

The node and or other computer holding and/or having access to the data might hold and/or have access to identifiers corresponding to one or more nodes and/or other computers that are to receive the data, for instance, in conjunction with one or more specifications of intermediate nodes and/or other computers, in conjunction with one or more proximity weights, in conjunction with one or more lists of nodes and/or other computers that are to receive the data, and/or in conjunction with one or more lists of groups of nodes and/or other computers that are to receive the data and one or more lists correlating nodes and/or other computers with groups.

The node and or other computer holding and/or having access to the data might learn of one or more identifiers of a node and/or other computer in proximity connection range in a number of ways. For instance, the node and or other computer holding and/or having access to the data might learn of one or more identifiers via inquiry and/or via one or more device discovery operations (e.g., Bluetooth device discovery operations).

In various embodiments, knowing of one or more identifiers of a node and/or other computer in proximity connection range and knowing of identifiers of nodes and/or other computers that are to receive the data, the node and/or other computer holding and/or having access to the data could act to dispatch the data to the node and/or other computer in proximity connection range in the case where an appropriate match was found.

As another example, in various embodiments the node and or other computer holding and/or having access to the data might alternately or additionally perform analysis and/or take analysis into account (e.g., it might perform and/or take into account statistical analysis) in determining if a node and/or or other computer in proximity connection range should receive held data. For instance, the node and or other computer holding and/or having access to the data might act to take into account one or more proximity weights, and/or frequencies and/or other statistics of the sort discussed above.

In various embodiments, the node and or other computer holding and/or having access to the data might, for example, act to dispatch the data to a node and/or other computer in proximity range that could serve as an intermediate node to reach an intended recipient node only in the case where one or more certain thresholds were met. Such a threshold might, for example, indicate a minimum proximity weight with respect to the node and/or other computer in proximity range. As another example, such a threshold might indicate a minimum frequency with which the node and/or other computer in proximity range should be in proximity connection range with the intended recipient node. Such thresholds might, for example, be set by system administrator, service provider, manufacturer, and/or user.

It is noted that, according to various embodiments, nodes and/or other computers might be considered as belonging to one or more networks (e.g., one or more peer-to-peer networks). It is further noted that, according to various embodiments, one or more operations may be performed in order to determine if nodes and/or other computers in proximity connection range with one another commonly belong to one or more such networks.

Accordingly, for instance, one or more operations might be performed to determine if nodes and/or other computers in proximity connection range with one another belonged to the same network. Thus, a node and/or other computer might perform one or more operations to learn if it had a network membership in common with a node and/or other computer in proximity range, and/or might perform one or more operations to determine if it and a node and/or other computer in proximity connection range belonged to the same network. Such functionality might be implement in a number of ways.

For example, inquiry, service discovery, and/or device discovery might be employed. For instance, the one or more networks to which a node and/or other computer in proximity connection range belonged might be determined via device discovery. Accordingly, for example, a node and/or other computer might employ device discovery to learn if it had a network membership in common with a node and/or other computer in proximity range, and/or if it and a node and/or other computer in proximity connection range belonged to the same network.

One or more operations might, for example, be performed to learn of status of other nodes and/or other computers (e.g., whether or not a node and/or other computer is able to receive data, and/or the amount of space a node and/or other computer has available for receiving data. Status of a node and/or other computer might be learned in a number of ways. For example, inquiry and/or service discovery might be employed.

Nodes and/or other computers may, in various embodiments, act to log information including the number of times other nodes and/or other computers are in proximity connection range, the dates and/or times of such encounters, the duration of such encounters, and/or the amount of space that is available for receiving data. Such logging might, in various embodiments, include one or more identifiers (e.g., phone numbers) corresponding to the other nodes and/or other computers.

It is noted that, in various embodiments, a node and/or other computer might act to only perform such logging with respect to other nodes and/or other computers that are members of one or more particular groups (e.g., one or more groups of which the node and/or other computer performing the logging is also a member). The duration of such an encounter might, for example, be determined in such a manner that an encounter is considered to be terminated in the case where another node and/or other computer ceases to be in proximity connection range and/or is no longer visible for inquires.

Some or all of logged information, in various embodiments, could be made available to other nodes and/or other computers (e.g., via service discovery and/or inquiry performed by those other nodes and/or other computers). Such information might, for example, be employed by the other nodes and/or other computers in determining to which nodes and/or other computers data should be dispatched for further propagation.

It is further noted that a node and/or other computer might, in various embodiments, perhaps in conjunction with logging operations, act to update status information corresponding to itself and might, perhaps, act to make such updated status information available to other nodes and/or other computers (e.g., via service discovery and/or inquiry performed by those other nodes and/or other computers).

In various embodiments, in the case where data is to be delivered to one or more other nodes and/or other computers, the data might be associated with a target group and/or due date. Such a group might, for instance, be selected by a user via a phonebook held by the node and/or other computer from which the data originates. The node and/or other computer from which the data originates might, for example, act to monitor for other nodes and/or other computers coming into proximity connection range.

In the case of another node and/or other computer being in proximity connection range, the node and/or other computer from which the data originates might, for example, connect to the other node and/or other computer and propose data transfer. The node and/or other computer from which the data originates might, perhaps, determine if the other node and/or other computer is a member of a recipient group before such proposal.

Perhaps after receiving approval, the node and/or other computer from which the data originates might, for instance, dispatch to the other node and/or other computer. Included in the dispatch might, for example, be the data to be delivered, an identifier, a list of nodes and/or other computers that are to receive the data, a list a nodes and/or other computers that have already received the data, and/or one or more group specifications. Such an identifier might, for instance, contain date and time of original dispatch of the data, and/or an identifier corresponding to the node and/or other computer that originally dispatched the data (e.g., the phone number of the node and/or other computer).

Receiving the dispatch, the node and/or other computer might, for instance, act to analyze that which is received and its own logs. In the case where the node and/or other computer determined that it met frequently enough (e.g., in accordance with a threshold specified by a system administrator, service provider, manufacturer, and/or user) with a node and/or other computer that was to receive the data, the node and/or other computer that has received the dispatch might save the data, and perhaps also save some or all of the associated information (e.g., an associated identifier) for later dispatch to other nodes and/or other computers. In various embodiments, the node and/or other computer receiving the dispatch could act to return data to the node and/or other computer from which it received the dispatch. Such returned data might include, for instance, logged information.

It is noted that a node and/or other computer might, in various embodiments, act to delete and/or ignore, and/or to refuse receipt of data of a dispatch in the case where it already held and/or had access to the data, and might keep and/or recognize, and/or receive only other portions of the dispatch (e.g., an identifier and/or one or more lists of nodes and/or other computers). It is further noted that, in various embodiments, a node and/or other computer from which the data originated might receive confirmation of receipt of data at nodes and/or other computers.

It additionally noted that, in various embodiments, a node and/or other computer that has received dispatch from an originating node and/or other computer might perform one or more operations analogous to those performed by the originating node and/or other computer in order to dispatch to further nodes and/or other computers.

According to various emoluments of the present invention, implementation of various functionality discussed herein might be such that client and/or server software operate on nodes and/or other computers. For example, both client and server software might operate on a node and/or other computer. It is further noted that, according to various embodiments, middleware might be employed in the implementation of various functionality discussed herein.

It is noted that, in various embodiments, various functionality discussed herein might, for example, be employed where dispatch of data via a narrowband cellular connection (e.g., GPRS) is considered to be too costly and/or too slow. Such might be the case, for instance, in the case where a large amount of data (e.g., a large file) is to be dispatched. It is noted that, in various embodiments, there might be no data transfer costs for various of the functionality discussed herein.

Hardware and Software

Various operations and/or the like described herein may be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, node, and/or the like, a server, a network access point, a network multicast point, a set-top box, a personal video recorder (PVR), a game console, or the like, perhaps running an operating system such as OS X, Linux, Darwin, Windows CE, Windows XP, Windows Server 2003, Palm OS, Symbian OS, or the like, perhaps employing the Series 40 Platform, Series 60 Platform, and/or Series 90 Platform, and perhaps having support for Java and/or .Net.

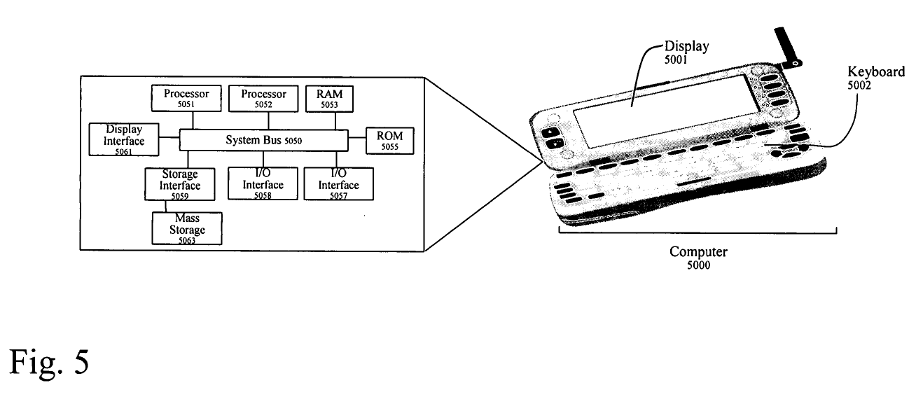

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 5000 as shown in FIG. 5 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Audio Broadcast (DAB), General Packet Radio Service (GPRS), Universal Mobile Telecommunications Service (UMTS), Global System for Mobile Communications (GSM), DVB-H (Digital Video Broadcasting: Handhelds), IrDA (Infrared Data Association), and/or other interface.

Mass storage 5063 may be a hard drive, optical drive, or the like. Processors 5051 and 5052 may each be a commonly known processor such as an IBM or Motorola PowerPC, an AMD Athlon, an AMD Opteron, an Intel ARM, an Intel XScale, a Transmeta Crusoe, a Transmeta Efficeon, an Intel Xenon, an Intel Itanium, or an Intel Pentium. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Xen according to methods known in the art. Corresponding program code might be placed on media such as, for example, DVD, CD-ROM, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed.

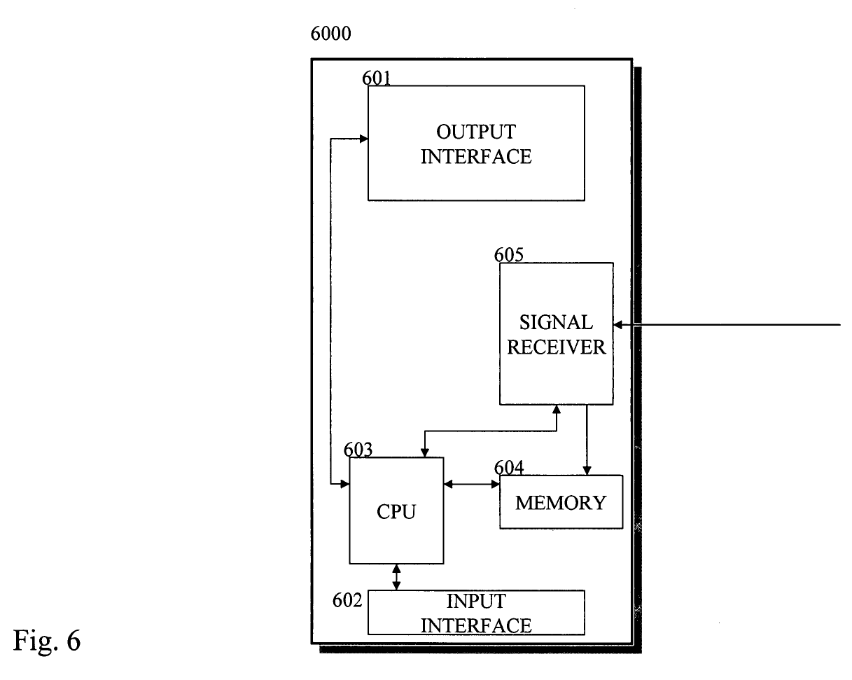

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604 and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
passing data, via proximity connection, from a first node to a second node while the second node is in proximity connection range of the first node but not in proximity connection range of a third node; and
passing the data, via proximity connection, from the second node to the third node while the second node is in proximity connection range of the third node but not in proximity connection range of the first node, wherein the second node has been translocated from proximity connection range of the first node to proximity connection range of the third node by action of a user of the second node,
wherein the second node is employed for data passing in view of proximity connection range encounters between nodes.

2. The method of claim 1, further comprising determining that the second node should be employed for data passing.

3. The method of claim 1, wherein the second node is employed for data passing in view of past proximity connection range encounters between nodes.

4. The method of claim 1, wherein the second node is employed for data passing in view of planned future proximity connection range encounters between nodes.

5. The method of claim 1, wherein the second node is employed for data passing in view of proximity connection range encounters between the second node and the third node.

6. The method of claim 1, wherein the second node is employed for data passing in view of proximity connection range encounters between the second node and the first node.

7. The method of claim 1, wherein the second node is employed for data passing in view of one or more calendar events.

8. The method of claim 1, wherein the second node is employed for data passing in view of a security attribute.

9. The method of claim 1, wherein the second node is employed for data passing in view of frequency of proximity connection range node encounters.

10. The method of claim 1, wherein the second node is employed for data passing in view of geographical locations visited by nodes.

11. The method of claim 1, wherein the second node is employed for data passing in view of one or more direct proximity weights.

12. The method of claim 1, wherein the second node is employed for data passing in view of one or more indirect proximity weights.

13. The method of claim 1, wherein proximity weights are exchanged between nodes.

14. The method of claim 13, wherein proximity weight exchange is via proximity connection.

15. The method of claim 1, wherein received proximity weights are employed in computation of indirect proximity weights.

16. The method of claim 1, wherein one or more proximity weights are discarded.

17. The method of claim 1, wherein one or more priorities are associated with passed data.

18. The method of claim 1, wherein no data transfer costs are incurred for data passing.

19. The method of claim 1, wherein a security attribute is applied to the data.

20. The method of claim 1, wherein a due date is set for the data.

21. The method of claim 1, wherein the first node receives a confirmation of proper receipt.

22. A method, comprising:
computing, at a first node, one or more proximity weights, wherein the proximity weights computed at the first node take into account proximity connection range node encounters;
receiving at the first node one or more proximity weights computed at a second node, wherein the proximity weights computed at the second node take into account proximity connection range node encounters; and
computing one or more further proximity weights at the first node, wherein the further proximity weights take into account one or more of the received proximity weights,
wherein data is dispatched via a series of node-to-node proximity connections from an initiating node to an intended recipient node, and wherein one or more nodes of the series are employed for dispatch in view of one or more proximity weights.

23. The method of claim 22, wherein one or more direct proximity weights computed at the second node are received at the first node.

24. The method of claim 22, wherein one or more indirect proximity weights values computed at the second node are received at the first node.

25. The method of claim 22, further comprising dispatching, from the first node to the second node, one or more proximity weights computed at the first node.

26. The method of claim 22, wherein the first node and the second node exchange proximity weights via proximity connection.

27. The method of claim 22, wherein one or more nodes of the series are employed for dispatch in view of past proximity connection range encounters between nodes.

28. The method of claim 22, wherein one or more nodes of the series are employed for dispatch in view of planned future proximity connection range encounters between nodes.

29. The method of claim 22, wherein one or more nodes of the series are employed for dispatch in view of one or more calendar events.

30. The method of claim 22, wherein one or more nodes of the series are employed for dispatch in view of a security attribute.

31. The method of claim 22, wherein one or more nodes of the series are employed for dispatch in view of frequency of proximity connection range node encounters.

32. The method of claim 22, wherein one or more nodes of the series are employed for dispatch in view of geographical locations visited by nodes.

33. The method of claim 22, wherein the one or more nodes of the series are employed for dispatch in view of one or more direct proximity weights.

34. The method of claim 22, wherein one or more nodes of the series are employed for dispatch in view of one or more indirect proximity weights.

35. The method of claim 22, wherein received proximity weights are employed in computation of indirect proximity weights.

36. The method of claim 22, wherein one or more proximity weights are discarded.

37. The method of claim 22, wherein one or more priorities are associated with dispatched data.

38. The method of claim 22, wherein no data transfer costs are incurred for data dispatch.

39. The method of claim 22, wherein a security attribute is applied to the data.

40. The method of claim 22, wherein a due date is set for the data.

41. The method of claim 22, wherein the first node receives a confirmation of proper receipt.

42. A system, comprising:
a memory having program code stored therein; and
a processor disposed in communication with the memory for carrying out instructions in accordance with the stored program code;
wherein the program code, when executed by the processor, causes the processor to perform:
passing data, via proximity connection, from a first node to a second node while the second node is in proximity connection range of the first node but not in proximity connection range of a third node,
wherein the data is passed, via proximity connection, from the second node to the third node while the second node is in proximity connection range of the third node but not in proximity connection range of the first node, wherein the second node has been translocated from proximity connection range of the first node to proximity connection range of the third node by action of a user of the second node, and
wherein the second node is employed for data passing in view of proximity connection range encounters between nodes.

43. The system of claim 42, wherein the processor further performs determining that the second node should be employed for data passing.

44. The system of claim 42, wherein the second node is employed for data passing in view of past proximity connection range encounters between nodes.

45. The system of claim 42, wherein the second node is employed for data passing in view of planned future proximity connection range encounters between nodes.

46. The system of claim 42, wherein the second node is employed for data passing in view of proximity connection range encounters between the second node and the third node.

47. The system of claim 42, wherein the second node is employed for data passing in view of proximity connection range encounters between the second node and the first node.

48. The system of claim 42, wherein the second node is employed for data passing in view of one or more calendar events.

49. The system of claim 42, wherein the second node is employed for data passing in view of a security attribute.

50. The system of claim 42, wherein the second node is employed for data passing in view of frequency of proximity connection range node encounters.

51. The system of claim 42, wherein the second node is employed for data passing in view of geographical locations visited by nodes.

52. The system of claim 42, wherein the second node is employed for data passing in view of one or more direct proximity weights.

53. The system of claim 42, wherein the second node is employed for data passing in view of one or more indirect proximity weights.

54. The system of claim 42, wherein proximity weights are exchanged between nodes.

55. The system of claim 54, wherein proximity weight exchange is via proximity connection.

56. The system of claim 42, wherein received proximity weights are employed in computation of indirect proximity weights.

57. The system of claim 42, wherein one or more proximity weights are discarded.

58. The system of claim 42, wherein one or more priorities are associated with passed data.

59. The system of claim 42, wherein no data transfer costs are incurred for data passing.

60. The system of claim 42, wherein a security attribute is applied to the data.

61. The system of claim 42, wherein a due date is set for the data.

62. The system of claim 42, wherein the first node receives a confirmation of proper receipt.

63. A system, comprising:
a memory having program code stored therein; and
a processor disposed in communication with the memory for carrying out instructions in accordance with the stored program code;
wherein the program code, when executed by the processor, causes the processor to perform:
computing, at a first node, one or more proximity weights, wherein the proximity weights computed at the first node take into account proximity connection range node encounters;
receiving at the first node one or more proximity weights computed at a second node, wherein the proximity weights computed at the second node take into account proximity connection range node encounters; and
computing one or more further proximity weights at the first node, wherein the further proximity weights take into account one or more of the received proximity weights,
wherein data is dispatched via a series of node-to-node proximity connections from an initiating node to an intended recipient node, and wherein one or more nodes of the series are employed for dispatch in view of one or more proximity weights.

64. The system of claim 63, wherein one or more direct proximity weights computed at the second node are received at the first node.

65. The system of claim 63, wherein one or more indirect proximity weights values computed at the second node are received at the first node.

66. The system of claim 63, wherein the processor further performs dispatching, from the first node to the second node, one or more proximity weights computed at the first node.

67. The system of claim 63, wherein the first node and the second node exchange proximity weights via proximity connection.

68. The system of claim 63, wherein one or more nodes of the series are employed for dispatch in view of past proximity connection range encounters between nodes.

69. The system of claim 63, wherein one or more nodes of the series are employed for dispatch in view of planned future proximity connection range encounters between nodes.

70. The system of claim 63, wherein one or more nodes of the series are employed for dispatch in view of one or more calendar events.

71. The system of claim 63, wherein one or more nodes of the series are employed for dispatch in view of a security attribute.

72. The system of claim 63, wherein one or more nodes of the series are employed for dispatch in view of frequency of proximity connection range node encounters.

73. The system of claim 63, wherein one or more nodes of the series are employed for dispatch in view of geographical locations visited by nodes.

74. The system of claim 63, wherein the one or more nodes of the series are employed for dispatch in view of one or more direct proximity weights.

75. The system of claim 63, wherein one or more nodes of the series are employed for dispatch in view of one or more indirect proximity weights.

76. The system of claim 63, wherein received proximity weights are employed in computation of indirect proximity weights.

77. The system of claim 63, wherein one or more proximity weights are discarded.

78. The system of claim 63, wherein one or more priorities are associated with dispatched data.

79. The system of claim 63, wherein no data transfer costs are incurred for data dispatch.

80. The system of claim 63, wherein a security attribute is applied to the data.

81. The system of claim 63, wherein a due date is set for the data.

82. The system of claim 63, wherein the first node receives a confirmation of proper receipt.

83. An article of manufacture comprising a computer readable medium containing program code that when executed causes a wireless node to perform:
passing data, via proximity connection, from the wireless node to a second node while the second node is in proximity connection range of the wireless node but not in proximity connection range of a third node,
wherein the data is passed, via proximity connection, from the second node to the third node while the second node is in proximity connection range of the third node but not in proximity connection range of the wireless node, wherein the second node has been translocated from proximity connection range of the wireless node to proximity connection range of the third node by action of a user of the second node, and
wherein the second node is employed for data passing in view of proximity connection range encounters between nodes.

84. An article of manufacture comprising a computer readable medium containing program code that when executed causes a wireless node to perform:
computing, at the wireless node, one or more proximity weights, wherein the proximity weights computed at the wireless node take into account proximity connection range node encounters;
receiving at the wireless node one or more proximity weights computed at a second node, wherein the proximity weights computed at the second node take into account proximity connection range node encounters; and
computing one or more further proximity weights at the wireless node, wherein the further proximity weights take into account one or more of the received proximity weights,
wherein data is dispatched via a series of node-to-node proximity connections from an initiating node to an intended recipient node, and wherein one or more nodes of the series are employed for dispatch in view of one or more proximity weights.
